(19) United States
(12) Patent Application Publication
(10) Pub. No.: US 2026/0187679 A1
(43) Pub. Date: Jul. 2, 2026

(54) SECURE ON-DEVICE DIGITAL CONTENT SELECTION

(71) Applicant: Google LLC, Mountain View, CA (US)

(72) Inventors: Gang Wang, Frederick, MD (US); Yue Wang, Los Altos, CA (US)

(21) Appl. No.: 18/857,709

(22) PCT Filed: Apr. 18, 2024
(86) PCT No.: PCT/US2024/025119

§ 371 Date: Oct. 17, 2024

Related U.S. Application Data
(60) Provisional application No. 63/497,625, filed on Apr. 21, 2023.

(51) Int. Cl. G06Q 30/0251; G06Q 30/0241

(52) U.S. Cl. CPC G06Q 30/0269; G06Q 30/0277

(57) ABSTRACT

Methods, systems, and apparatus, including computer programs encoded on a computer storage medium, for selecting and displaying digital components at client devices in ways that securely maintains user data and protects user privacy are described. In one aspect, a method includes storing, by a client device of a user, a first set of candidate digital components selected based on user data of the user. A digital component management application running on the client device sends, to a trusted server, a digital component request that requests a second set of candidate digital components. The digital component request comprising contextual data describing an environment in which a digital component will be presented. The digital component management application selects a given digital component from among the first set of digital components and the second set of digital components. The given digital component is displayed at the client device.

### CROSS-REFERENCE TO RELATED APPLICATIONS

This application claims priority to U.S. Provisional Application No. 63/497,625, filed on Apr. 21, 2023. The disclosure of the prior application is considered part of and is incorporated by reference in the disclosure of this application.

### TECHNICAL FIELD

This specification is related to data processing, data privacy, and data security.

### BACKGROUND

Data security and user privacy are vital in systems and devices connected to public networks, such as the Internet. The enhancement of user privacy has led many developers to change the ways in which user data is handled. For example, some browsers are planning to deprecate the use of third-party cookies.

### SUMMARY

In general, one innovative aspect of the subject matter described in this specification can be embodied in methods including the operations of storing, by a client device of a user, a first set of candidate digital components selected based on user data of the user; sending, by a digital component management application running on the client device and to a trusted server, a digital component request that requests a second set of candidate digital components, the digital component request comprising contextual data describing an environment in which a digital component will be presented; receiving, by the digital component management application and from the trusted server, the second set of candidate digital components; selecting, by the digital component management application, a given digital component from among the first set of digital components and the second set of digital components; and displaying the given digital component at the client device. Other implementations of this aspect include corresponding apparatus, systems, and computer programs, configured to perform the aspects of the methods, encoded on computer storage devices.

These and other implementations can each optionally include one or more of the following features. In some aspects, storing the first set of candidate digital components includes receiving, by the digital component management application and from a digital component provider, registration data requesting that a particular digital component be registered as a candidate digital component for the client device based on user activity of the user at a resource of the digital component provider; obtaining, by digital component management application, the particular digital component from the trusted server in response to receiving the data identifying the request data; and storing, digital component management application, the particular digital component in a local digital component repository of the client device.

In some aspects, storing the first set of candidate digital components includes receiving, by the digital component management application from a content platform, request data requesting that the user of the client device be added to a particular user interest group that includes users that are identified as being interested in a topic of interest of the user interest group; sending, by the digital component management application and to the trusted server, a request for candidate digital components for which distribution criteria of the candidate digital component specifies that the candidate digital component is eligible for display to users of the user interest group; receiving, by the digital component management application and from the trusted server, one or more candidate digital components in response to the request; and storing, by the digital component management application, the one or more digital components in a local digital component repository of the client device.

Some aspects include updating, by the digital component management application, user group membership information indicating user interest groups that include the user as a member, the user group membership information being stored at the client device.

In some aspects, storing the first set of candidate digital components includes sending, by the digital component management application, batch requests for candidate digital components to the trusted server, wherein each batch request comprises at least one of (i) data identifying registered candidate digital components that have been registered at the client device or (ii) data identifying a set of user interest groups that include the user of the client device as a member.

Some aspects include sending, by the digital component management application and to the trusted server, impression notification data indicating that the given digital component was displayed at the client device.

Some aspects include detecting user interaction with the given digital component and sending, by the digital component management application and to the trusted server, user interaction notification data indicating that user interaction with the given digital component occurred at the client device.

In some aspects, the trusted server is configured to aggregate notifications received from multiple client devices and send, to content platforms, aggregated reports that indicate quantities of impressions and/or user interactions with digital components of the content platforms.

In some aspects, the digital component management application runs in a trusted execution environment of the client device.

Particular embodiments of the subject matter described in this specification can be implemented so as to realize one or more of the following advantages. Using the techniques described in this document, sensitive user data that is useful in selecting and/or customizing content for a user is maintained on the user's device, where it can be maintained securely, its use can be controlled by the user, and other entities cannot track the user across the Internet or sell the user's data to other entities, thereby enhancing data security and user privacy. The user's device can include an application that is configured to manage the processes of obtaining content, e.g., digital components, for display to the user, securely storing the user's data, and/or selecting content to display to the user, e.g., based at least in part on the stored data.

Digital components can be retrieved and stored at users' devices to reduce the latency in selecting and displaying digital components to the users and reduce battery consumption and network bandwidth that would otherwise be consumed to download the digital component each time that it is selected for display at the devices. The digital components stored on a user's device can be selected based on activities of the user and/or user data of the user. In this way, relevant digital components that are likely to be of interest to a user and that are likely to be selected for display to the user can be stored on the user's device without wasting limited data storage space on irrelevant digital components. Thus, the described techniques can reduce latency in displaying digital components without tying up a large amount of data storage space of user devices resulting in enhanced security and memory management.

Historically, third-party cookies (e.g., cookies from a different domain than the resource being rendered by a client device) have been used to collect data from client devices across the Internet. However, some browsers and device platforms block the use of third-party cookies and third-party cookies are increasingly being removed from use, thereby preventing the collection of data using third party cookies. This creates a challenge when attempting to utilize collected data to make inferences, segment data, or otherwise utilize data to enhance online browsing experiences, e.g., by selecting content relevant to users based on the data collected using third party cookies. In other words, without the use of third-party cookies, much of the data previously collected is no longer available, which prevents computing systems from being able to use that data to group users based on shared user attributes or activities performed by the users at particular web pages or other resources, to enhance the online experience for users, and/or to present relevant content to users.

The techniques described in this document can solve hurdles that may arise from the eradication of third-party cookies. For example, content platforms that distribute digital components to users can add users to user interest groups based on known (if provided by the user) or inferred data for the user. A user's interest group membership information can be stored at the user's device and used to select relevant digital components for display to the user without sending such data to content platforms or other entities. In this way, no content platform has access to more than one user interest group of the user but the user's membership across multiple user interest groups can be used to select digital components for the user. In another example, digital component providers can register digital components for display at the user's device based on activities of the user, e.g., by registering a digital component for a user that visited a web page of the digital component provider. In this example, a digital component that is related to these activities can be displayed to the user later without having to provide information specifying the activities from the user's device or having to provide a third-party cookie that would enable the digital component provider to re-identify the user. The user interest group membership and/or registered digital component data can be stored at the user's device and used to select digital components for display to the user without the use of third-party cookies. Thus, the described technologies improve data privacy and data security by making third-party cookies obsolete.

Using a trusted server to select digital components based on user data provides better security of the user data relative to techniques that involve the use of third-party cookies or other mechanisms for sending user data across the Internet. For example, this limits the user data to one recipient when the data is off the user's device. The trusted server can include a trusted execution environment (TEE) that processes the user data to select digital components, thereby reducing the ability of such data to be leaked to other entities. The trusted server can execute code, logic, or rules of content providers to select digital components to provide to the user's device based on the user data, thereby obviating the need to send third-party cookies or other forms of user data to the content providers.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are selected and displayed to users in privacy preserving manners.

FIG. 2 is a flow diagram of an example process for obtaining and storing candidate digital components at a client device in a privacy preserving manner.

FIG. 3 is a flow diagram of an example process for selecting and displaying a digital component in a privacy preserving manner.

FIG. 4 is a block diagram of an example computer system.

Like reference numbers and designations in the various drawings indicate like elements.

### DETAILED DESCRIPTION

In general, this document describes systems and techniques for selecting and displaying digital components at client devices in ways that securely maintains user data and protects user privacy. A digital component management application can run on client devices of users and manage the processes of managing user data securely, obtaining candidate digital components based on the user data and/or other data, selecting digital components for display at the client device, and/or reporting notifications. The digital component management application can interact with a trusted server to obtain digital components based on user data such that user data is not provided to other entities, such as content platforms or digital component providers, within the online ecosystem. Processes that involve user data at the client device and/or at the trusted server can be performed in trusted execution environments (TEE) to ensure that the processes are executed in ways that prevent access to the user data outside of the TEE(s).

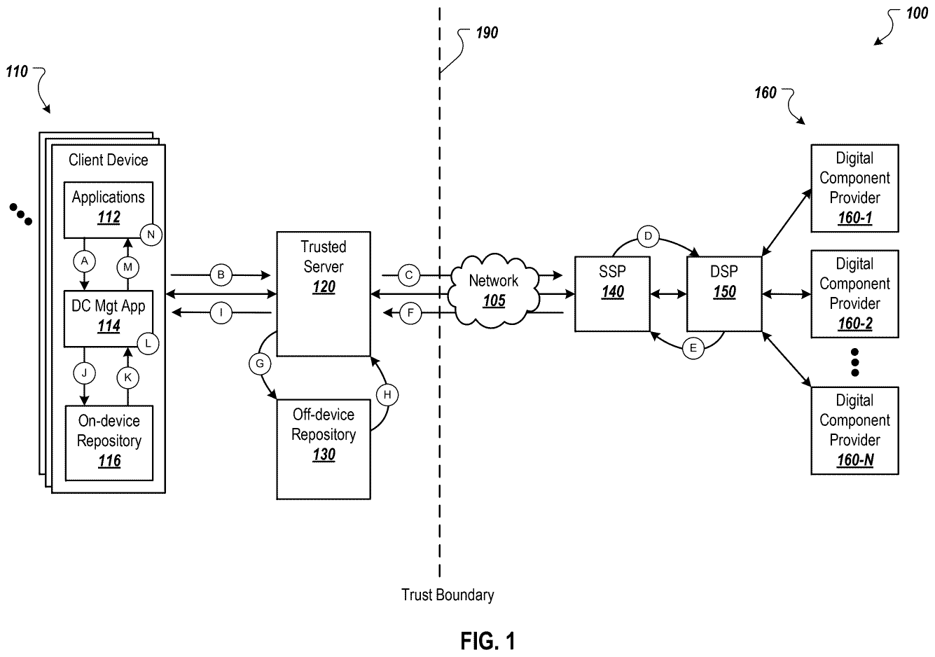

FIG. 1 is a block diagram of an example environment 100 in which digital components are selected and displayed to users in privacy preserving manners. The environment 100 includes a data communication network 105, such as a local area network (LAN), a wide area network (WAN), the Internet, a mobile network, or a combination thereof. The data communication network 105 connects client devices 110 to the trusted server 120 and connects the trusted server 120 to content platforms, such as supply side platforms (SSPs) 140 and/or demand side platforms (DSPs) 150. The network 105 can also connect the various content platforms to one another and/or to digital component providers 160, e.g., to servers of the digital component providers 160.

A client device 110 is an electronic device that is capable of communicating over the network 105. Example client devices 110 include personal computers, server computers, mobile communication devices, e.g., smart phones and/or tablet computers, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., watch or glasses), a smart phone, a speaker device, a tablet device, or another hardware device. A client device can also include a digital media device, e.g., a streaming device that plugs into a television or other display to stream videos to the television, a gaming device, or a virtual reality system.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

A client device 110 can include applications 112, such as web browsers and/or native applications, to facilitate the sending and receiving of data over the network 105. A native application is an application developed for a particular platform or a particular device (e.g., mobile devices having a particular operating system).

The applications 112 can display electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of this document, a resource can refer to a web page, application page, application content presented by a native application, electronic document, audio stream, video stream, or other appropriate type of electronic resource with which a digital component can be presented.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for presentation in the digital component slot. In some implementations, the digital component slot and/or the resource can include code (e.g., scripts) that cause the application 112 to request a digital component from the trusted server 120. In another example, an application 112 can include a software development kit (SDK), code generated using an SDK, or other appropriate code that is configured to generate digital component requests to request digital components for display with other content (e.g., primary content) of the resource being displayed by the application 112.

The digital component request can include contextual data. The contextual data can be related to, e.g., describe, the environment in which a selected digital component will be displayed. The contextual data can include, for example, coarse location information indicating a general location of the client device 110, data identifying a resource (e.g., website or native application) with which the selected digital component will be displayed, a spoken language setting of the application 112 or client device 110, the number of digital component slots in which digital components will be presented with the resource, the types of digital component slots, the size and arrangement of the digital components slots, and/or other appropriate contextual information. Data identifying a resource can be in the form of a resource locator, such as a Universal Resource Locator (URL) or Universal Resource Identifier (URI).

Applications 112 can be configured to send digital component requests to SSPs 140 and/or to a digital component management application 114 running on the client device 110. If the digital component will be selected based on user data, the digital component request can be sent to the digital component management application 114. If user data or other sensitive data is not going to be used, the digital component request can be sent to the SSP 140.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The digital component management application 114 is configured to manage user data of the user of the client device 110 and to manage processes for obtaining and selecting digital components for display at the client device 110. User data for a user can include, for example user attribute data (e.g., demographics data), user interest group membership information that indicates user interest groups that include the user as a member, and/or other appropriate data about the user if the user has allowed use of such information.

The digital component management application 114 can generate and display user interfaces that enable the user to specify if user data can be stored by the digital component management application 114, what types of user data can be stored, and/or how the user data is used. In this way, users have control over the storage and use of their data, and visibility as to how such data is being stored and used.

Each user interest group can include a topic of interest. If the user is determined or predicted to be interested in the topic, the user can be added to the user interest group. For example, the digital component management application 114 can update the user membership information to indicate that the user is a member of the user interest group. This information can be stored securely at the client device 110 and not sent past a trust boundary 190.

A content platform 140, 150, digital component provider 160, or publisher of a resource can request that the digital component management application 114 add the user to a user interest group. A content platform 140, 150 can request that the digital component management application 114 add the user to a user interest group based on contextual data of a digital component request received from the trusted server 120 on behalf of the client device 110. In this example, the content platform 140, 150 does not receive data identifying the user of the client device 110 but may infer that the user may be interested in a particular topic based on the resource identified by the digital component request and/or other contextual data in the digital component request. The content platform 140, 150 can request that the digital component management application 114 add the user to a user interest group by including the request in a response to the digital component request. The response can include one or more digital components to be considered as candidates for display at the client device 110 and/or a request to add the user to a user interest group.

A digital component provider 160 can publish resources that include information about items that are the subject of digital components. Other publishers, e.g., news organizations, also publish resources, e.g., news web sites or application pages of news applications. These publishers can request that the application 112 add the user to a user interest group based on a resource requested by the application 112 and/or user activities with the resource, e.g., user selection of an item displayed by the resource. In this example, the publisher can submit the request to the digital component management application 114 via the application 112.

A content platform 140, 150 or digital component provider 160 can also register digital components with the digital component management application 114. For example, a digital component provider 160 can register a digital component as a candidate digital component for display to the user based on a resource requested by the application 112 and/or user activities with the resource, similar to the process for adding the user to a user interest group. In a particular example, if the user interacts with an item or requests a resource that includes content about the item, the digital component platform 160 can request that the digital component management application 114 add a digital component with additional content about the item to the on-device repository 116 and to consider the digital component for selection and display to the user of the client device 110.

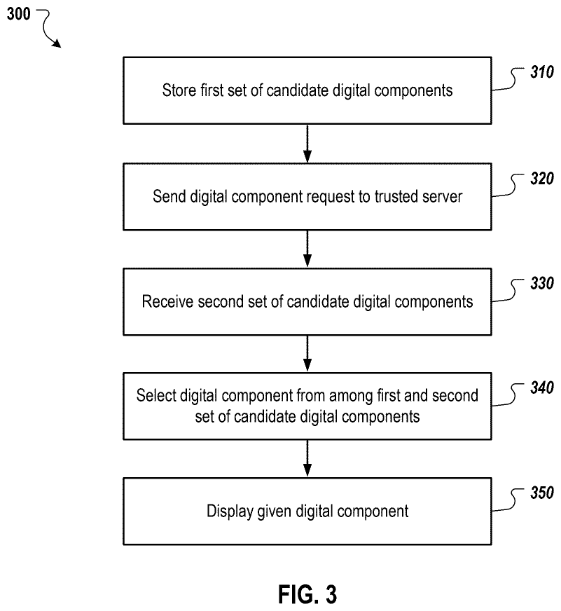

The digital component management application 114 is configured to select a digital component from one or more sets of candidate digital components in response to receiving a digital component request from an application 112. The candidate digital components can include a first set of candidate digital components stored in an on-device digital component repository 116 and/or a second set of candidate digital components obtained from the trusted server 120 based on contextual data of the digital component request. As described in more detail below, the first set of candidate digital components can be obtained from the trusted server 120 can stored in the on-device repository 116 periodically. The second set of candidate digital components can be obtained at request time, e.g., in response to receiving the digital component request from an application 112. An example process for selecting a digital component is illustrated in FIG. 3 and described below.

The trusted server 120 is configured to obtain candidate digital components for the client device 110 in ways that prevent content platforms 140, 150 from learning anything about the user, thereby enhancing user privacy. The trusted server 120 can be implemented using one or more server computers (or other appropriate computing devices), that may be distributed across multiple locations. As the trusted server 120 receives sensitive user data, the trusted server 120 can be operated and maintained by an independent trusted party, e.g., a party that is different from the users of the client devices, the parties that operate the SSPs 140 and DSPs 150, and the digital component providers 160. For example, the trusted server 120 can be operated by an industry group or a governmental group.

The trusted server 120 provides isolation between the client device 110 and the content platforms 140, 150. Rather than send digital component requests directly to SSPs 140, the digital component management application 114 can send digital component requests to the trusted server 120 (e.g., for digital components selected based on contextual data) and the trusted server 120 can interact with the SSPs 140 obtain these candidate digital components and related information. In this way, the SSPs 140 do not obtain information about the client device 110, such as an Internet Protocol (IP) address of the client device 110.

The trusted server 120 can also obtain candidate digital components for the client device 110 based on user data of the user of the client device 110. For example, the digital component management application 114 can request, from the trusted server 120, candidate digital components for storage in the on-device repository 116 based on the user interest groups that include the user as a member. The digital component management application 114 can provide, to the trusted server 120, data identifying the user interest groups for the user (e.g., the user groups that include the user as a member). The trusted server 120 can select digital components from an off-device digital component repository 130 based on the user interest groups and/or request digital components from content platforms based on the user interest groups without providing data identifying the user or client device 110 to which the user interest group data belongs. The trusted server 120 can provide the selected digital components to the digital component management application 114 for storage in the on-device repository 116.

In another example, the digital component management application 114 can request, from the trusted server 120, digital components that have been registered with the digital component management application 114, as described above. In this example, the digital component management application 114 can provide, to the trusted server 120, data identifying the registered digital components and/or data identifying the content platform 140, 150 or digital component provider 160 that registered the digital component with the digital component management application 114. The trusted server 120 can obtain the digital component from the appropriate entity and provide the digital component to the digital component management application 114 without providing data about the user or the client device 110 to that entity. This is another example of isolation provided by the trusted server 120.

The trusted server 120 can maintain the off-device digital component repository 130 to include a set of digital components that can be provided to digital component management applications 114 running on client devices 110. This off-device digital component repository 130 can store a large number of digital components, e.g., orders of magnitude greater than those stored in the on-device digital component repositories 116. The trusted server 120 can obtain the digital components for the off-device digital component repository 130 from content platforms 140, 150, e.g., periodically or when the content platforms 140, 150 provide updates to the off-device digital component repository 130.

The off-device digital component repository 130 can store, for the digital components, distribution criteria. The distribution criteria for a digital component can define under what circumstances the digital component is eligible for display at a client device 110 and/or one or more selection values for the digital component. The selection value for a digital component can represent an amount that the content platform 140, 150 is willing to provide to a publisher for displaying the digital component with a resource of the publisher. The distribution criteria for a digital component can include one or more user interest groups for which the digital component is eligible for display (e.g., the digital component is eligible for display to users that are members of these user interest groups) and/or one or more user interest groups for which the digital component is not eligible for display (e.g., the digital component is not eligible for display to users that are members of these user interest groups).

The distribution criteria for a digital component can also include a set of one or more contextual features for which the digital component is eligible and/or a set of one or more contextual features for which the digital component is not eligible. For example, a digital component may be eligible for display to users in one geographic region, but not to users in another geographic region. The on-device repository 116 can include the same or similar distribution criteria for the digital components stored therein.

The trusted server 120 is also configured to generate aggregate reports related to digital components displayed at client devices 110. The digital component management application 114 of multiple client devices 110 can send, to the trusted server 120, impression notifications, user interaction notifications, and/or conversion notifications. An impression notification can include data related to a digital component displayed at a client device 110. This data can identify the digital component, the date and/or time at which the digital component was displayed and/or a resource with which the digital component was displayed.

A user interaction notification can include data related to a digital component that was interacted with by a user of the client device 110. This data can identify the digital component, the date and/or time at which the digital component was interacted with and/or a resource with which the digital component was displayed when the user interaction occurred.

A conversion notification can include data related to a digital component that led to a conversion event. This data can identify the digital component, the date and/or time at which the digital component was displayed, a date and/or time at which the conversion occurred, and/or a resource with which the digital component was displayed.

The trusted server 120 can determine aggregate measures for digital components across multiple client devices 110 using the notifications. For example, the trusted server 120 can determine quantities of impressions, user interaction rates, and/or conversion rates for the digital components based on the notifications. The trusted server 120 can provide the aggregated measures for a digital component to the content platform 140, 150 and/or digital component provider 160 corresponding to the digital component. In this way, the content platforms 140, 150 and digital component providers 160 do not receive individual notifications for individual users or client devices 110 and therefor user tracking based on such information is prevented.

The processes performed by the trusted server 120 and/or the processes performed by the digital component management application 114 can be performed within a trusted execution environment (TEE). For example, the client device 110 can include a TEE and digital component management application 114 and/or processes related to the on-device repository 116 can be ran within the TEE. Similarly, the trusted server 120 can include a TEE in which any process that operates on user data is performed.

A TEE is a computing environment where the code that is executed and the data that is being accessed is isolated and protected in terms of confidentiality and integrity. A TEE can be implemented using both computer hardware and software. For example, a TEE can include a hardware isolation mechanism and software, e.g., an operating system, executing on the hardware isolation mechanism. Using a TEE can prevent processes that operate on user data from being able to send the user data outside the TEE, which protects user privacy.

Including a TEE for the trusted server 120 and/or for the digital component management application 114 also enables verification that the binaries that define the processes are official builds from a sectioned codebase. This prevents an entity from using fraudulent code within the TEE to send user data off device.

The trusted server 120 can be implemented using one or more server computers (or other appropriate computing devices), that may be distributed across multiple locations. In general, the trusted server 120 receives requests for digital components from client devices 110, selects digital components based on data included in the requests, and sends the selected digital components to the client devices 110.

An SSP 140 is a technology platform implemented in hardware and/or software that automates the process of obtaining digital components for the resources. Publishers of resources can use an SSP 140 to manage the process of obtaining digital components for digital component slots of its resources. Each publisher can have a corresponding SSP 140 or multiple SSPs 140. Some publishers may use the same SSP 140.

A DSP 150 is a technology platform implemented in hardware and/or software that automates the process of distributing digital components for presentation with the resources and/or applications. A DSP 150 can interact with multiple supply-side platforms SSPs on behalf of digital component providers 160 to provide digital components for presentation with the resources of multiple different publishers. Digital component providers 160 can create (or otherwise publish) digital components that are presented in digital component slots of publisher's resources.

In this example, user data does not cross a trust boundary 190 that separates the client device 110 and the trusted server 120 from the rest of the environment 100, e.g., from the digital component repository from the SSP 140, DSP 150, and digital component providers 160. In this way, no entity other than the client device 110 and the trusted server 120 receives the user data maintained at the client device 110. This preserves user privacy and data security, especially when compared to techniques that employ third-party cookies to send user data across the Internet.

An example process for selecting and providing a digital component for display at a client device 110 is illustrated in stages A-M, which illustrate a flow of data between the components of the environment 100.

In stage A, the application 112 sends a digital component request to the digital component management application 114. As described above, the application 112 can send a digital component request to request a digital component for presentation in a digital component slot of a resource being presented by the application 112. The digital component request can include contextual data.

In stage B, the digital component management application 114 sends a digital component request to the trusted server 120. This digital component request can be a context-based digital component request that includes the contextual data of the digital component request received from the application 112, and/or other contextual data identified by the digital component management application 114.

In stage C, the trusted server 120 sends a context-based digital component request to an SSP 140. The context-based digital component request can include the contextual data of the digital component request received from the digital component management application 114. The trusted server 120 can send the context-based digital component request to an SSP 140 for the publisher of the resource being presented by the application 112.

In some implementations, the trusted server 120 can be configured to evaluate digital component requests received from client devices 110. For example, the trusted server 120 can be configured to detect whether the digital component is fraudulent and, if so, ignore the digital component request and/or block requests received from that client device 110 in the future.

In stage D, the SSP 140 forwards the context-based digital component request to one or more DSPs 150. In stage E, each DSP 150 sends, to the SSP 140, one or more digital components and a selection value for each digital component. For example, the DSP 150 can select a digital component based on the contextual data of the context-based request and determine a selection value for the digital component based on the contextual data. Each DSP 150 can send a selection value with data indicating the digital component to which the selection parameter applies. As described above, the DSP 150 can also send request data to add the user to one or more user interest groups and/or to register one or more digital components as candidates for the user of the client device 110.

In stage F, the SSP 140 sends the digital components and/or selection values to the trusted server 120. In some implementations, the SSP 140 can filter digital components and/or selection values prior to sending the digital components and/or selection values to the trusted server 120. For example, the SSP 140 can filter digital components and/or selection values based on publisher controls specified by the publisher of the resource being presented by the application 112. In a particular example, a publisher of a web page about a particular event may define, as a publisher control, that digital components related to another event may not be presented with this web page. The SSP 140 can filter based on rules or other data provided by the publisher.

In stage G, the trusted server 120 queries the digital component repository 130 for digital components. In some implementations, the trusted server 120 can be configured to retrieve digital components based on user data, if any received in the digital component request received from the digital component management application 114. If such data is received, the data is not provided to the SSP 140 or DSP 150.

The trusted server 120 can submit a query that defines, as conditions of the query, the user data of the digital component request. In some implementations, the query can also include context-based conditions. For example, a query can request retrieval of digital components that include, as distribution criteria, a particular user group and/or a particular geographic location. Although shown after stages C-F, the trusted server 120 can query the digital component repository in parallel with these stages to reduce the latency in selecting and providing digital components to the digital component management application 114.

In stage H, the trusted server 120 receives zero or more digital components from the off-device digital component repository 130 and a selection value for each digital component. The digital components can include those having distribution criteria that matches the conditions of the query.

In stage I, the trusted server 120 sends the digital components and corresponding selection values received from the SSP 140 and/or retrieved from the off-device digital component repository 130 to the digital component management application 114. In some implementations, the trusted server 120 can be configured to filter these digital components, e.g., based on publisher controls, digital component standards, etc. The digital components provided to the digital component management application 114 can be those remaining after the filtering operation. This set of digital components can be referred to a second set of candidate digital components that are candidates for selection and display to the user of the client device 110

In stage J, the digital component management application 114 queries the on-device digital component repository 116 for a first set of candidate digital components based on user data and/or the contextual data of the digital component request. This is the same as or similar to stage G, but locally for the digital components stored in the on-device digital component repository 116. Although shown after stages B-I, the digital component management application 114 can query the digital component repository in parallel with these stages to reduce the latency in selecting and providing a digital component to the application 112.

In stage K, the digital component management application 114 receives zero or more digital components from the on-device digital component repository 116 and a selection value for each digital component. The digital components can include those having distribution criteria that matches the conditions of the query.

In stage L, the digital component management application 114 selects a digital component to provide to the application 112 for display with the resource of the application 112. The digital component management application 114 can select a digital component from the first and second sets of candidate digital components. The digital component management application 114 can select the digital component from the two sets based on the selection value for each digital component in the two sets. For example, the digital component management application 114 can select the digital component having the highest selection value. Other data, such as predicted performance of the digital components, can also be used in selecting the digital component.

In stage M, the digital component management application 114 provides the selected digital component to the application 112. In stage N, the application 112 can display the digital component with the resource being presented by the application 112.

In addition, the digital component management application 114 can send notifications to the trusted server 120. For example, upon display of the digital component, the digital component management application 114 can send an impression notification to the trusted server 120, as described above.

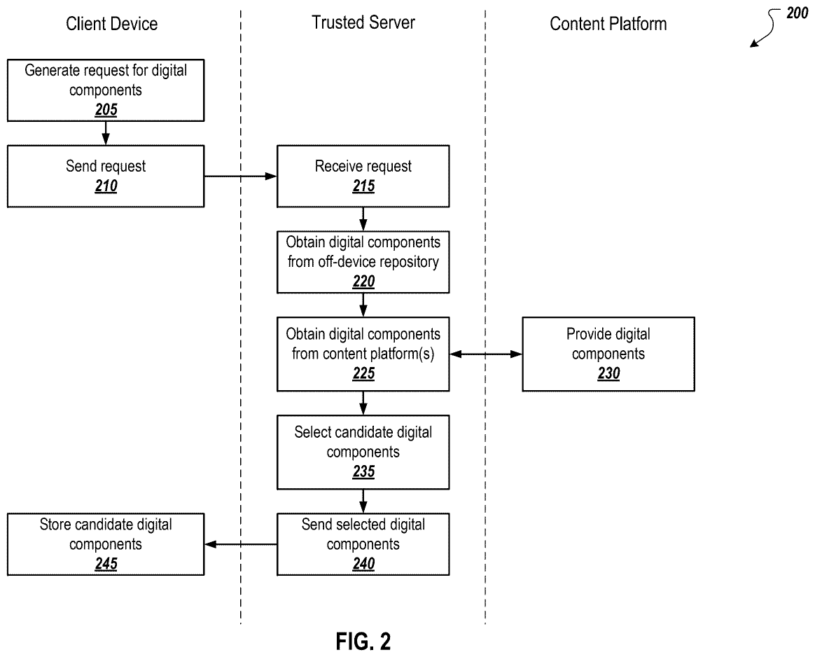

FIG. 2 is a flow diagram of an example process 200 for obtaining and storing candidate digital components at a client device in a privacy preserving manner. Operations of the process 200 can be performed by a client device 110, a trusted server 120, and a content platform (e.g., SSP 140) of FIG. 1. Operations of the process 200 can also be implemented as instructions stored on one or more computer readable media, which may be non-transitory, and execution of the instructions by one or more data processing apparatus can cause the one or more data processing apparatus to perform the operations of the process 200.

The digital component management application 114 of the client device 110 generates a request for digital components to store in the on-device digital component repository 116 (205). This request can include, for example, user group membership data that identifies user interest groups that include the user of the client device 110 as a member and/or digital components that have been registered by the digital component management application 114 in response to requests from content platforms 140, 150, digital component providers 160, and/or other publishers.

The digital component management application 114 sends the request to the trusted server 120 (210). The trusted server 120 receives the request (215).

The trusted server 120 obtains digital components from the off-device digital component repository 130 (220). The trusted server 120 can query the off-device digital component repository 130 for digital components having distribution criteria that is satisfied by the user's group membership. For example, the trusted server 120 can query the off-device digital component repository 130 for digital components having distribution criteria that specifies that the digital component is eligible for display to users in a user interest group that matches one of the user's interest groups as indicated by the user group membership data. The trusted server 120 can filter those digital components for which the user is a member of a user interest group for which the digital component is not eligible for display.

The trusted server 120 obtains digital components from content platforms 140, 150 (225). For example, the trusted server 120 can request digital components that have been registered at the client device 110 by the content platforms 140, 150, digital component providers 160, and/or other publishers. Each request can identify a registered digital component. The content platforms 140, 150 (and/or other entities) can provide the requested digital components (230).

The trusted server 120 selects candidate digital components to provide to the digital component management application 114 (235). As the on-device digital component repository 116 can be small relative to the off-device digital component repository 130, the trusted server 120 can select from those obtained from the off-device digital component repository 130 and/or the content platforms 140, 150. The trusted server 120 can select the digital components for storage in the on-device digital component repository 116 based on one or more factors, such as a likelihood that the user will interact (e.g., select the digital component), a level of match between user data of the user data and distribution criteria of the digital component, a level of match between the contextual data and distribution criteria of the digital component, the selection value for the digital component, and/or other factors.

The trusted server 120 sends the selected candidate digital components to the digital component management application 114 (240). The digital component management application 114 stores the received digital components in the on-device digital component repository 116 (245).

FIG. 3 is a flow diagram of an example process 300 for selecting and displaying a digital component in a privacy preserving manner. Operations of the process 300 can be performed by a digital component management application 114 running on a client device 110. Operations of the process 300 can also be implemented as instructions stored on one or more computer readable media, which may be non-transitory, and execution of the instructions by one or more data processing apparatus can cause the one or more data processing apparatus to perform the operations of the process 300.

The digital component management application 114 stores a first set of candidate digital components (310). The first set of candidate digital components selected based on user data of the user of the client device. For example, the first set of digital components can include those obtained using one or more iterations of the process 200 of FIG. 2.

A digital component request is sent to the trusted server 120 (320). The digital component request can include contextual data and/or user data. The contextual data can be related to the environment in which a selected digital component will be displayed. The user data can include the user group membership data for the user and/or digital components registered at the client device 110 for the user.

The digital component management application 114 receives a second set of candidate digital components from the trusted server 120 (330). As described above, the trusted server 120 can obtain candidate digital components from content platforms 140, 150 based on the contextual data. In some implementations, the trusted server 120 can also obtain candidate digital components from its off-device digital component repository 130 based on user data.

The digital component management application 114 selects a given digital component from among the first set of candidate digital components and the second set of candidate digital components (340). The digital component management application 114 can select a digital component based on selection values for the candidate digital components and/or actual or predicted performance measures for the candidate digital components. For example, the digital component management application 114 can determine a score for each candidate digital component that is based on the selection value and the performance measure for the candidate digital component. The digital component management application 114 can then select the candidate digital component having the highest score. The performance measure can be a predicted or actual user interaction rate or a predicted or actual conversion rate.

In some implementations, the digital component management application 114 is configured to execute logic (e.g., in the form of computer readable code, such as scripts or worklets or in the form of a set of rules or model, such as a trained machine learning model) of content platforms for selecting a digital component. A content platform can provide logic to client devices 110. The logic can be configured to select, from among digital components of the content platform stored at the client device 110, a candidate digital component for a selection process and/or generate a selection value for the candidate digital component based on the contextual data and/or user data of the user. If operating on user data, the digital component management application 114 can be configured to execute the logic in a TEE.

The given digital component is displayed (350). For example, the digital component management application 114 can provide the given digital component to an application 112 running on the client device 110 for display with primary content of the application 112. The application 112 can display the given digital component with the primary content.

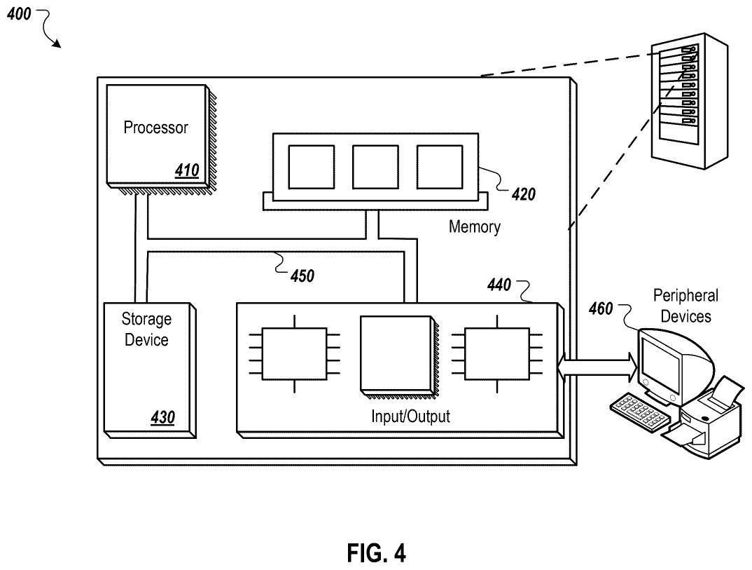

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
storing, by a client device of a user, a first set of candidate digital components selected based on user data of the user;
sending, by a digital component management application running on the client device and to a trusted server, a digital component request that requests a second set of candidate digital components, the digital component request comprising contextual data describing an environment in which a digital component will be presented;
receiving, by the digital component management application and from the trusted server, the second set of candidate digital components;
selecting, by the digital component management application, a given digital component from among the first set of digital components and the second set of digital components; and
displaying the given digital component at the client device.

2. The computer-implemented method of claim 1, wherein storing the first set of candidate digital components comprises:
receiving, by the digital component management application and from a digital component provider, registration data requesting that a particular digital component be registered as a candidate digital component for the client device based on user activity of the user at a resource of the digital component provider;
obtaining, by digital component management application, the particular digital component from the trusted server in response to receiving the data identifying the request data; and
storing, digital component management application, the particular digital component in a local digital component repository of the client device.

3. The computer-implemented method of claim 1, wherein storing the first set of candidate digital components comprises:
receiving, by the digital component management application from a content platform, request data requesting that the user of the client device be added to a particular user interest group that includes users that are identified as being interested in a topic of interest of the user interest group;
sending, by the digital component management application and to the trusted server, a request for candidate digital components for which distribution criteria of the candidate digital component specifies that the candidate digital component is eligible for display to users of the user interest group;
receiving, by the digital component management application and from the trusted server, one or more candidate digital components in response to the request; and
storing, by the digital component management application, the one or more digital components in a local digital component repository of the client device.

4. The computer-implemented method of claim 3, further comprising updating, by the digital component management application, user group membership information indicating user interest groups that include the user as a member, the user group membership information being stored at the client device.

5. The computer-implemented method of claim 1, wherein storing the first set of candidate digital components comprises sending, by the digital component management application, batch requests for candidate digital components to the trusted server, wherein each batch request comprises at least one of (i) data identifying registered candidate digital components that have been registered at the client device or (ii) data identifying a set of user interest groups that include the user of the client device as a member.

6. The computer-implemented method of claim 1, further comprising sending, by the digital component management application and to the trusted server, impression notification data indicating that the given digital component was displayed at the client device.

7. The computer-implemented method of claim 6, further comprising:
detecting user interaction with the given digital component; and
sending, by the digital component management application and to the trusted server, user interaction notification data indicating that user interaction with the given digital component occurred at the client device.

8. The computer-implemented method of claim 6, wherein the trusted server is configured to aggregate notifications received from a plurality of client devices and send, to content platforms, aggregated reports that indicate quantities of impressions and/or user interactions with digital components of the content platforms.

9. The computer-implemented method of claim 1, wherein the digital component management application runs in a trusted execution environment of the client device.

10. A system comprising:
one or more processors; and
one or more storage devices storing instructions that, when executed by the one or more processors, cause the one or more processors to perform operations comprising:
storing a first set of candidate digital components selected based on user data of the user;
sending, to a trusted server, a digital component request that requests a second set of candidate digital components, the digital component request comprising contextual data describing an environment in which a digital component will be presented;
receiving, from the trusted server, the second set of candidate digital components;
selecting a given digital component from among the first set of digital components and the second set of digital components; and
displaying the given digital component at a client device.

11. A non-transitory computer readable medium storing instructions that, when executed by one or more processors, cause the one or more processors to perform operations comprising:
storing a first set of candidate digital components selected based on user data of the user;
sending, to a trusted server, a digital component request that requests a second set of candidate digital components, the digital component request comprising contextual data describing an environment in which a digital component will be presented;
receiving, from the trusted server, the second set of candidate digital components;
selecting a given digital component from among the first set of digital components and the second set of digital components; and
displaying the given digital component at a client device.

12. (canceled)

13. The non-transitory computer readable medium of claim 11, wherein storing the first set of candidate digital components comprises:
receiving, from a digital component provider, registration data requesting that a particular digital component be registered as a candidate digital component for the client device based on user activity of the user at a resource of the digital component provider;
obtaining the particular digital component from the trusted server in response to receiving the data identifying the request data; and
storing the particular digital component in a local digital component repository of the client device.

14. The non-transitory computer readable medium of claim 11, wherein storing the first set of candidate digital components comprises:
receiving, from a content platform, request data requesting that the user of the client device be added to a particular user interest group that includes users that are identified as being interested in a topic of interest of the user interest group;
sending, to the trusted server, a request for candidate digital components for which distribution criteria of the candidate digital component specifies that the candidate digital component is eligible for display to users of the user interest group;
receiving, from the trusted server, one or more candidate digital components in response to the request; and
storing the one or more digital components in a local digital component repository of the client device.

15. The non-transitory computer readable medium of claim 14, wherein the instructions cause the one or more processors to perform operations further comprising updating user group membership information indicating user interest groups that include the user as a member, the user group membership information being stored at the client device.

16. The non-transitory computer readable medium of 11, wherein storing the first set of candidate digital components comprises sending batch requests for candidate digital components to a trusted server, wherein each batch request comprises at least one of (i) data identifying registered candidate digital components that have been registered at a client device or (ii) data identifying a set of user interest groups that include the user of the client device as a member.

17. The non-transitory computer readable medium of claim 11, wherein the instructions cause the one or more processors to perform operations further comprising sending, to the trusted server, impression notification data indicating that the given digital component was displayed at the client device.

18. The system of claim 10, wherein storing the first set of candidate digital components comprises:
receiving, from a digital component provider, registration data requesting that a particular digital component be registered as a candidate digital component for the client device based on user activity of the user at a resource of the digital component provider;
obtaining, by digital component management application, the particular digital component from the trusted server in response to receiving the data identifying the request data; and
storing, digital component management application, the particular digital component in a local digital component repository of the client device.

19. The system of claim 10, wherein storing the first set of candidate digital components comprises:
receiving, from a content platform, request data requesting that the user of the client device be added to a particular user interest group that includes users that are identified as being interested in a topic of interest of the user interest group;
sending, to the trusted server, a request for candidate digital components for which distribution criteria of the candidate digital component specifies that the candidate digital component is eligible for display to users of the user interest group;
receiving, from the trusted server, one or more candidate digital components in response to the request; and
storing the one or more digital components in a local digital component repository of the client device.

20. The system of claim 19, wherein the instructions cause the one or more processors to perform operations further comprising updating user group membership information indicating user interest groups that include the user as a member, the user group membership information being stored at the client device.

21. The system of 10, wherein storing the first set of candidate digital components comprises sending batch requests for candidate digital components to a trusted server, wherein each batch request comprises at least one of (i) data identifying registered candidate digital components that have been registered at a client device or (ii) data identifying a set of user interest groups that include the user of the client device as a member.

22. The system of claim 10, wherein the instructions cause the one or more processors to perform operations further comprising sending, to the trusted server, impression notification data indicating that the given digital component was displayed at the client device.

23. The system of claim 22, wherein the instructions cause the one or more processors to perform operations further comprising:
detecting user interaction with the given digital component; and
sending, to the trusted server, user interaction notification data indicating that user interaction with the given digital component occurred at the client device.
